(19) United States
(12) Patent Application Publication
(10) Pub. No.: US 2021/0324230 A1
(43) Pub. Date: Oct. 21, 2021

(54) COATING COMPOSITION AND PRINTABLE MEDIUM

(71) Applicant: Hewlett-Packard Development Company, L.P., Spring, TX (US)

(72) Inventors: Xiaoqi Zhou, San Diego, CA (US); Zhang-Lin Zhou, San Diego, CA (US)

(21) Appl. No.: 17/270,235

(22) PCT Filed: Dec. 17, 2019
(86) PCT No.: PCT/US2019/066722

§ 371 Date: Feb. 22, 2021

(30) Foreign Application Priority Data
Dec. 18, 2018 (US) PCT/US2018/066169

(51) Int. Cl. C09D 175/06; C09D 175/08; C08G 18/75; C08G 18/32; C08G 18/42; C08G 18/66; C08G 18/08; D06P 5/00

(52) U.S. Cl. CPC C09D 175/06; C09D 175/08; C08G 18/755; C08G 18/3206; D06P 5/30; C08G 18/664; C08G 18/758; C08G 18/0828; D06P 5/002; C08G 18/4238

(57) ABSTRACT

A coating composition comprising water, water-soluble cationic phosphonium salts and polyurethane particles including sulfonated- or carboxylated-diamine groups, isocyanate-generated amine groups, and polyalkylene oxide side-chains. Also disclosed is a coated printable medium, with an image-side and a back-side, comprising a base substrate and the coating composition, such as described herein, that is applied over, at least, one side of the base substrate, forming an image-receiving layer. Also disclosed is the method for making such printable medium.

### BACKGROUND

Inkjet printing technology has expanded its application to large format high-speed, commercial and industrial printing, in addition to home and office usage, because of its ability to produce economical, high quality, multi-colored prints. This technology is a non-impact printing method in which an electronic signal controls and directs droplets or a stream of ink that can be deposited on a wide variety of medium substrates. Inkjet printing technology has found various applications on different substrates including, for examples, cellulose paper, metal, plastic, fabric, textile and the like. The substrate plays a key role in the overall image quality and permanence of the printed images. Textile printing has various applications including the creation of signs, banners, artwork, apparel, wall coverings, window coverings, upholstery, pillows, blankets, flags, tote bags, etc. It is a growing and evolving area and is becoming a trend in the visual communication market. As the area of textile printing continues to grow and evolve, the demand for new coating compositions and printable mediums increases.

With these printing technologies, it is apparent that the image quality of printed images is strongly dependent on the construction of the recording media used. Pre-treatment compositions or coatings can be applied to various media to improve printing characteristics and attributes of a printed image.

### BRIEF DESCRIPTION OF THE DRAWINGS

The drawings illustrate various examples of the present fabric printable medium and are part of the specification.

FIG. 1 and FIG. 2 are a cross-sectional view of the printable medium according to some examples of the present disclosure.

FIG. 3 is a flowchart illustrating a method for producing the printable medium according to one example of the present disclosure.

FIG. 4 is an example portions of polyurethane particles that can be included in coating compositions and print media coatings in accordance with the present disclosure.

### DETAILED DESCRIPTION

When printing on media substrates, specifically on fabric substrates, challenges exist due to the specific nature of media and of the fabrics. Indeed, often, some media such as fabric does not accurately receive inks. Some fabrics, for instance, can be highly absorptive, diminishing color characteristics, while some synthetic fabrics can be crystalline, decreasing aqueous ink absorption leading to ink bleed. These characteristics result in the image quality on fabric being relatively low. Additionally, black optical density, color gamut, and sharpness of the printed images are often poor compared to images printed on other media types. Durability, such as rubbing resistance, is another concern when printing on fabric, particularly when pigmented inks and ink compositions containing latex are used. To overcome these challenges, a functional coating, such as an image-receiving coating, is applied to the surface of the fabric substrate. However, since coating compositions contain some flammable substances such as polymeric binders, when such fabric printing media is intended to be used in close proximity to indoor environments (as drapes, as overhead signage, as part of furnishings, or the like), there are concerns about flame resistance as well as about using coatings that increase the flammability of the fabric. Thus, fire/flame resistance or inhibition characteristics of the coating compositions are also desirable when providing printable fabrics.

In one example, the present disclosure is drawn to a coating composition comprising water, water-soluble cationic phosphonium salts and polyurethane particles including sulfonated- or carboxylated-diamine groups, isocyanate-generated amine groups, and polyalkylene oxide side-chains. In some other examples, the present disclosure relates to a coated printable medium, with an image-side and a back-side, comprising a base substrate and a coating composition applied over, at least, one side of the base substrate, forming an image-receiving layer, and comprising water-soluble cationic phosphonium salts and polyurethane particles including sulfonated- or carboxylated-diamine groups, isocyanate-generated amine groups, and polyalkylene oxide side-chains. The present disclosure also relates to a method for forming said coated printable medium.

The present technology relates to coating compositions for print media. Such coating composition can be applied to various media to improve, for example, printing characteristics and attributes of an image. In some examples, the coating composition is a composition that is going to be applied to an uncoated printable recording media. By “uncoated”, it is meant herein that the printable recording media has not been treated or coated by any composition. By “coated”, it is meant herein that the printable recording media has been applied a composition. It is noted that the term “coating composition” refers to either a composition used to form a coating layer as well as the coating layer itself, the context dictating which is applicable. For example, a coating composition or coating that includes an evaporable solvent is referring to the compositional coating that is applied to a media substrate. Once coated on a media substrate and after the evaporable solvent is removed, the resulting coating layer can also be referred to as a coating.

The present technology relates also to printable medium comprising a coating composition. In some specific examples, the printable medium is a fabric printable medium. When coated with the coating composition according to the present disclosure, the printable recording medium (or printable media) provide printed images that have outstanding print durability and excellent scratch resistance while maintaining good printing image quality (i.e. printing performance). In addition, the printable medium, when coated with the coating composition according to the present disclosure, has good flame resistance properties.

As good printing characteristics, it is meant herein good black optical density, good color gamut and sharpness of the printed image. The images printed on the printable medium will thus be able to impart excellent image quality: vivid color, such as higher gamut and high color density. High print density and color gamut volume are realized with substantially no visual color-to-color bleed and with good coalescence characteristics. The images printed on the fabric printable medium will have excellent durability; specifically, it will have excellent durability under mechanical actions such as rubbing and scratching. The printable medium, according to the present disclosure, is a printable recording medium (or printable media) that provide printed images that have outstanding print durability and excellent scratch resistance while maintaining good printing image quality (i.e. printing performance). In addition, the fabric printable medium has good flame resistance properties. By “scratch resistance”, it is meant herein that the composition is resistant to any modes of scratching which include, scuff and abrasion. By the term “scuff”, it is meant herein damages to a print due to dragging something blunt across it (like brushing fingertips along printed image). Scuffs do not usually remove colorant, but they do tend to change the gloss of the area that was scuffed. By the term “abrasion”, it is meant herein the damage to a print due to wearing, grinding or rubbing away due to friction. Abrasion is correlated with removal of colorant (i.e. with the OD loss).

In some examples, the fabric printable medium described herein is a coated printable media that can be printed at speeds needed for commercial and other printers such as, for example, HP Latex printers such as 360, 560, 1500, 3200 and 3600 (HP Inc., Palo Alto, Calif., USA). The image printed on the fabric printable medium of the present disclosure exhibits excellent printing qualities and durability. By using coating compositions, in combination with fabric substrate, the printing process is more accurate, and the printed image is more permanent. The resultant printed fabric will also be able to provide fire/flame resistance or inhibition to the fabric. The present disclosure refers to a fabric printable medium comprising a fabric base substrate and coating compositions applied to said fabric base substrate. The coating compositions, also called treatment compositions, once applied on the fabric base substrate, are solidified and form thin layers onto the fabric base surface.

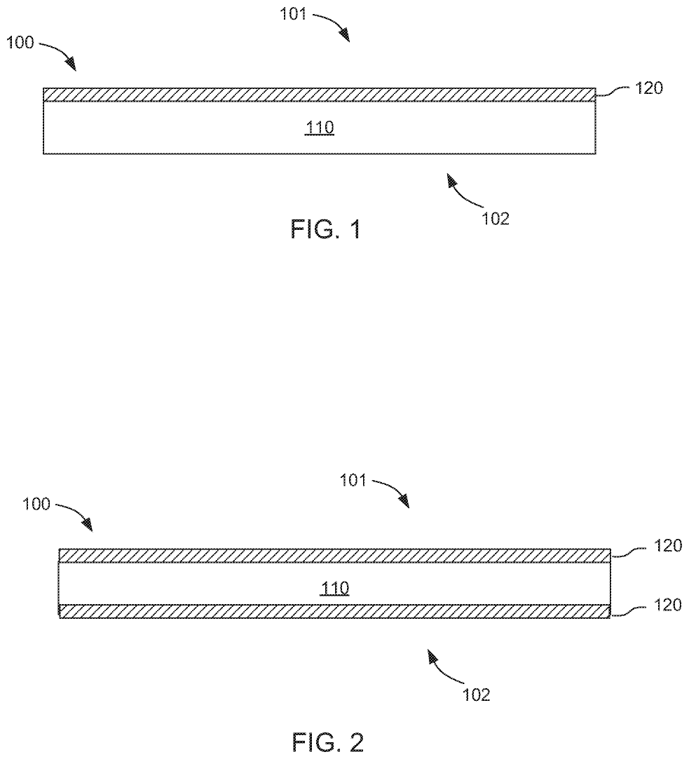

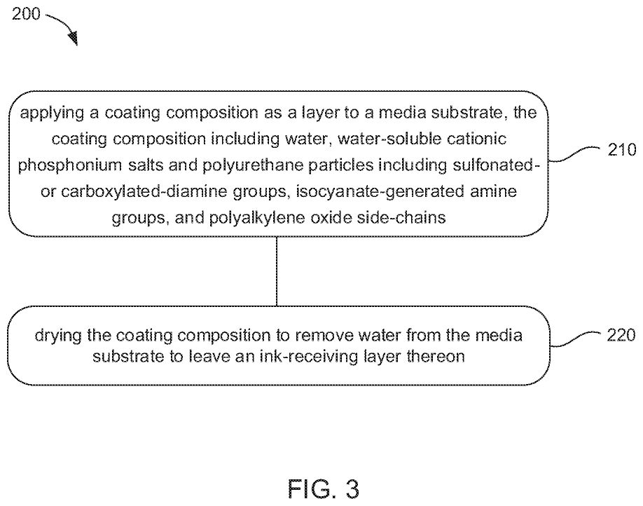

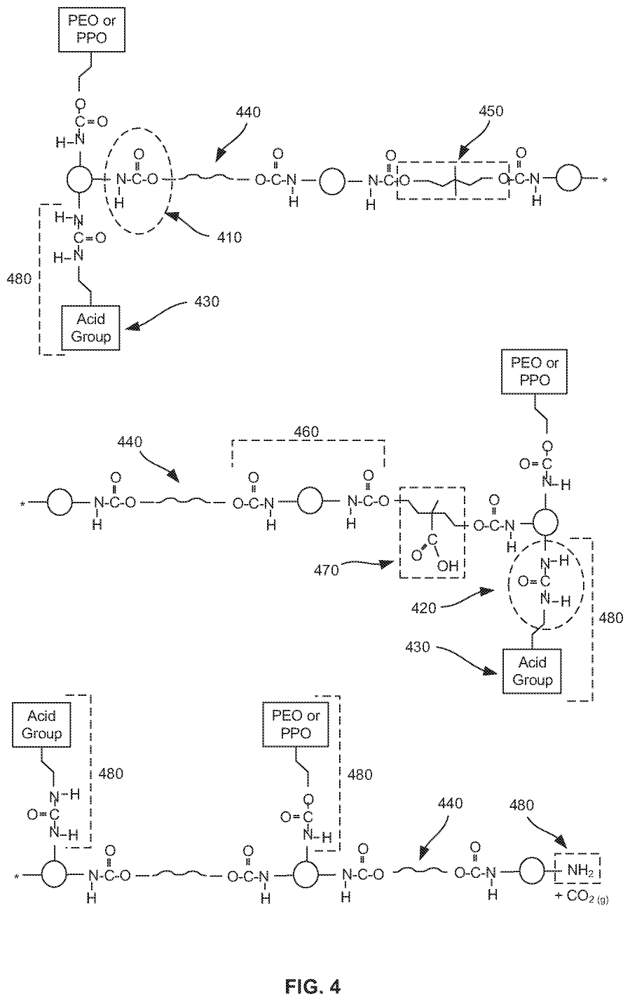

FIG. 1 and FIG. 2 schematically illustrate some examples of the printable medium (100) as described herein. FIG. 3 is a flowchart illustrating an example of a method for producing the printable medium. FIG. 4 is an example portions of polyurethane particles that can be included in coating compositions and print media coatings described herein.

As will be appreciated by those skilled in the art, FIG. 1 and FIG. 2 illustrate the relative positioning of the various layers of the printable media without necessarily illustrating the relative thicknesses of the various layers. It is to be understood that the thickness of the various layers is exaggerated for illustrative purposes.

FIG. 1 illustrates the printable recording media (100) as described herein. The printable media (100) encompasses a base substrate or media substrate or bottom supporting substrate (110) and a coating layer (120) that result from the application of the coating composition as described herein. The coating composition is applied on, at least, one side of the substrate (110) in order to from an image-receiving layer (120). The image side with the image-receiving layer is considered as the side where the image will be printed. The printable medium (100) has two surfaces: a first surface which might be referred to as the “image-receiving side”, “image surface” or “image side” (101) when coated with the image-receiving layer and the primary layer, and a second surface, the opposite surface, which might be referred to as the “back surface” or “back-side” (102).

In some other examples, such as illustrated in FIG. 2, the printable medium (100) encompasses a base substrate (110) with image-receiving coating layers (120) that are applied on both sides, on the image (101) and on the back-side (102), of the base substrate (110). In theory, both the image side and the back-side could thus be printed

An example of a method (200) for forming a printable medium in accordance with the principles described herein, by way of illustration and not limitation, is shown in FIG. 3. As illustrated in FIG. 3, such method encompasses applying a coating composition as a layer to a media substrate, the coating composition including water, water-soluble cationic phosphonium salts and polyurethane particles including sulfonated- or carboxylated-diamine groups, isocyanate-generated amine groups, and polyalkylene oxide side-chains (210) and drying the coating composition to remove water from the media substrate to leave an ink-receiving layer thereon (220) in order to obtain the printable medium. When applied on a printable medium, the coating composition, that comprises water, Water-soluble cationic phosphonium salts and polyurethane particles including sulfonated- or carboxylated-diamine groups, isocyanate-generated amine groups, and polyalkylene oxide side-chains, will form the image-receiving coating layer.

The coating composition comprises water-soluble cationic phosphonium salts. In some examples, water-soluble cationic phosphonium salts is an organic compounds with a molecular weight that is less than 1,000.

In some examples, the water-soluble cationic phosphonium salts are present in the coating composition in an amount representing between 0.5% and 50% of the total weight of the coating composition. In some other examples, the water-soluble cationic phosphonium salts are present in the coating composition in an amount representing between 2% and 30% of the total weight of the coating composition. In yet some other examples, the water-soluble cationic phosphonium salts are present in the coating composition in an amount representing between 5% and 20% of the total weight of the coating composition.

The water-soluble cationic phosphonium salts, described herein, can provide multiple functions in the coating composition, such as being a flame retardant, a pigment colorant fixer, and a crosslinker to the salt-compatible polyurethane described later.

In some examples, when used in coating composition for coating media with fabric base substrate, the water-soluble cationic phosphonium salts, described herein will act as flame retardant agent. As “flame-retardant”, or “fire-retardant”, it is meant herein any substance (i.e. agent) that inhibits or reduces flammability or delays their combustion of the substance (i.e. herein the media) containing it. In other word, the flame-retardant agent will have flame or fire retardancy properties.

It is believed that the hydroxyl group(s) that are present on the phosphonium salt molecules can contribute hydrophilic characteristic to the salt to make it water-soluble and can form a single-phase coating solution with water and water dispersible-salt-compatible polyurethane. Further, the hydroxyl groups can crosslink with salt-compatible polyurethane described later.

The phosphonium salt can contain single or multiple hydroxyl groups connecting directly with phosphorus element. Scheme 1 gives a general structure of water-soluble cationic phosphonium salts.

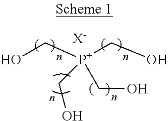

Wherein, X⁻ can be any counterion and n is an integers ranging from 1 to 10. In some examples, the counterion X⁻ of water-soluble cationic phosphonium salts can be any elements such as Cl⁻, Br⁻, I⁻, F⁻, SO₄²⁻, MeSO³⁻, p-MeC₆H₄SO³⁻ etc.

In one example, the water-soluble cationic phosphonium salt is tetrakis(hydroxymethyl) phosphonium chloride (Scheme 2) and in another example, the water-soluble cationic phosphonium salts is bis[tetrakis(hydroxymethyl)phosphonium]sulfate (Scheme 3).

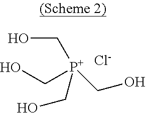

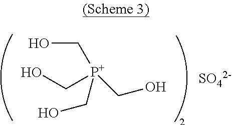

These water-soluble cationic phosphonium salts can be commercially available from multiple channels such as, for example, Sigma-Aldrich, Santa Cruz Biotechnology, Inc and Kisum Deng Wuhan Dachu Hexing Technology Co., Ltd, China

The coating composition comprises salt-compatible polyurethane particles. By definition, the “salt-compatible polyurethane particles” refer to a polyurethane emulsion, or latex, which can withstand the ionic attacking from an ionic species such as a salt. The word “withstand” refers there is no gelling and/or precipitation when polyurethane latex and salt solution is mixed at any concentration. The salt-compatible polyurethane can be considered as a film-forming polymer which will form a flexible but tough networked film, or at least on large portions of the surface of the fabric surface to provide the coating composition with durability against mechanical stress, such rubbing scratching and fractioning. The film may not perfectly cover the fabric surface due to fabric open holes. The salt-compatible polyurethane also plays a role as the binder to the cationic phosphonium salts so that they will not be removed during application like in printing. The salt-compatible polyurethane has polyurethane backbone on its molecule chains. Unlike most of polyurethane in the market which is readily be crashed out by any salt or cationic species, the polyurethane described herein is salt-compatible by the way to copolymerize PEO/PPO structure onto the backbone of the molecular chain, which in turn reveal salt-compatible characteristic.

In some examples, the polyurethane particles are present in the coating composition in an amount representing between 2% and 50% of the total weight of the coating composition. In some other examples, the polyurethane particles are present in the coating composition in an amount representing between 5% and 30% of the total weight of the coating composition. In yet some other examples, the polyurethane particles are present in the coating composition in an amount representing between 10% and 40% of the total weight of the coating composition.

The polyurethane particles of the present disclosure include sulfonated- or carboxylated-diamine groups, isocyanate-generated amine groups, and polyalkylene oxide side-chains. In one example, the polyalkylene oxide side-chains include polyethylene oxide side-chains, polypropylene oxide side-chains, or a combination thereof. The polyalkylene oxide side-chains can have a number average molecular weight from 500 Mn to 5,000 Mn.

The term “isocyanate-generated amine groups” refers to amino (—NH₂) groups that can be generated from excess isocyanate (NCO) groups that are not utilized when forming the polymer precursor, typical present as terminal groups; or to secondary amine (—NH—) groups that may be isolated from other functional groups present along the polymer backbone, e.g., —CH₂CH₂—NH—CH₂—. These groups can be generated from excess isocyanate (NCO) groups that are not utilized when forming polymer precursor or at other stages in the reaction/preparation of the polyurethane polymer. Upon reacting with water (rather than being used to form the polymer backbone with a diol) the excess isocyanate group can release carbon dioxide, leaving an amino or secondary amine group where the isocyanate group was previously present.

In further detail, as mentioned, there can be two different types of amine groups present on the polyurethane particles, namely sulfonated- or carboxylated-alky diamine groups and isocyanate-generated amine groups. The sulfonated- or carboxylated alky diamine groups can be reacted with a polymer precursor, resulting in some examples as a pendant side chain with one of the amine groups attaching the pendant side chain to a polymer backbone and the other amine group and sulfonate or carboxylate group being present along the pendant side chain. As an example of a carboxylate- or sulfonated diamine, Formula I below shows an alkylamine-alkylamine sulfonate (shown as a sulfonic acid, but as a sulfonate, would include a positive counterion associated with an SO₃⁻ group), that can be used to form the polyurethane particles of the present disclosure, though there are others, including other alkyl diamines sulfonates, alkyl diamine carboxylates, alicyclic diamine sulfonates, alicyclic diamine carboxylates, aromatic diamine sulfonates, aromatic diamine carboxylates, or combinations thereof. Thus, the alkyl diamine sulfonates shown in Formula I is below is provide by way of example, as follows:

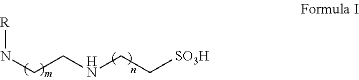

where R is H or is C₁ to C₁₀ straight- or branched-alkyl or alicyclic or combination of alkyl and alicyclic, m is 1 to 5, and n is 1 to 5. One example of such a structure sold by Evonik Industries (USA) is A-95, which is exemplified where R is H, m is 1, and n is 1. Another example structure sold by Evonik Industries is Vestamin®, where R is H, m is 1, and n is 2.

The isocyanate-generated amine groups, on the other hand, can be generated from excess isocyanate (NCO) groups that are not utilized when forming the polymer precursor, as also mentioned. In further detail, the isocyanate-generated amine groups can be present on the polyurethane particles at from 2 wt % to 8 wt % compared to a total weight polyurethane particle.

The polyurethane particles, as mentioned, also include polyalkylene oxide side-chains, shown schematically at “C,” for example. These side-chains can be grafted onto polyurethane polymers, such as Sancure™ polyurethanes are available from Lubrizol Advanced Materials, Inc., USA, or Impranil® polyurethanes are available from Covestro AG, Germany. However, if left unmodified, these polyurethanes are not polyurethanes are not considered to have polyalkyeneoxide side-chains. The polyalkylene oxide side-chains can include polyethylene oxide side-chains, polypropylene oxide side-chains, or a combination thereof. The polyalkylene oxide side-chains can have a number average molecular weight from 500 Mn to 15,000 Mn, or from 1,000 Mn to 12,000 Mn, from 2,000 Mn to 10,000 Mn, or from 3,000 Mn to 8,000 Mn. These side-chains can provide one example benefit of assisting the polyurethane particles with compatibility when co-formulated with a fixing agent, for example. The polyurethane particles can have a D50 particle size from 20 nm to 300 nm, from 75 nm to 250 nm, or from 125 nm to 250 nm, for example. The weight average molecular weight can be from 30,000 Mw to 300,000 Mw, from 50,000 Mw to 250,000 Mw, or from 100,000 Mw to 200,000 Mw.

In some examples, the acid number of the polyurethane particles is lower than 30. The acid number of the polyurethane particles can be from 0 mg KOH/g to 30 mg KOH/g, from 2 mg KOH/g to 20 mg KOH/g, or from 4 mg KOH/g to 15 mg KOH/g, for example.

In some other example, the Glass transition temperature (Tg) value of this polyurethane dispersion is less than 25° C.

In some other examples, the polyurethane particles have a D50 particle size from 20 nm to 300 nm and have an acid number ranging from 0 mg KOH/g to 30 mg KOH/g. In yet some other examples, the polyurethane particles includes sulfonated- or carboxylated-diamine groups, isocyanate-generated amine groups, and polyalkylene oxide side-chains; the polyalkylene oxide side-chains include polyethylene oxide side-chains, polypropylene oxide side-chains, or a combination thereof, and the polyalkylene oxide side-chains have a number average molecular weight from 500 Mn to 15,000 Mn.

In yet some other examples, the polyurethane particles includes sulfonated- or carboxylated-diamine groups, isocyanate-generated amine groups, and polyalkylene oxide side-chains; the polyalkylene oxide side-chains include polyethylene oxide side-chains, polypropylene oxide side-chains, or a combination thereof, and the polyalkylene oxide side-chains have a number average molecular weight from 500 Mn to 15,000 Mn and have a D50 particle size from 20 nm to 300 nm and have an acid number ranging from 0 mg KOH/g to 30 mg KOH/g.

By way of example, the polyurethane particles of the present disclosure can be prepared, in one example, by reacting a diisocyanate with a polymer diol and a small molecule diol, e.g., in the presence of a catalyst in acetone under reflux, to give a compound ready for grafting in the polyethylene oxide (PEO) and/or polypropylene oxide (PPO). Thus, pre-polymer synthesis can include reaction of a diisocyanate with polymeric diol and a small molecular aliphatic diol, for example. The term “aliphatic” as used herein includes saturated C2 to C16 aliphatic groups, such as alkyl groups, alicyclic groups, combinations of alkyl and alicyclic groups, etc., and can include straight-chain alkyl, branched alkyl, alicyclic, branched alkyl alicyclic, straight-chain alkyl alicyclic, alicyclic with multiple alkyl side chains, etc. For example, the small molecule nonionic aliphatic diol can have from C₂ to C₁₆ carbon atoms, for example; or if the sulfonated- or carboxylated-diamine group(s) are described as aliphatic diamines, they can include sulfonated- or carboxylated C₂ to C₁₆ carbons in addition to be a diamine.

The reaction can occur in the presence of a catalyst in acetone under reflux to give the pre-polymer, in one example. In some specific examples, other reactants may also be used in certain specific examples, such as organic acid diols (in addition to the polymeric diols) to generate acidic moieties along the backbone of the polyurethane particles. Thus, in addition to diols that may be used to react with the isocyanate groups to form the urethane linkages, a carboxylated diol may likewise be used to react with the diisocyanates to add carboxylated acid groups along a backbone of the polyurethane polymer of the polyurethane particles.

The pre-polymer can be prepared with excess isocyanate groups that compared the molar concentration of the alcohol groups found on the polymeric diols or other diols that may be present. By retaining excess isocyanate groups, in the presence of water, the isocyanate groups can generate amino groups or secondary amines along the polyurethane chain, releasing carbon dioxide as a byproduct. This reaction can occur at the time of chain extension during the process of forming the polyurethane particles. Once the pre-polymer is formed, the polyurethane particles can be generated by reacting the pre-polymer with mono-substituted polyethylene oxide (PEO) alcohol and/or polypropylene oxide (PPO) alcohol, and then with sulfonated- or carboxylated-diamines, to form the polyurethane particles that include the sulfonated- and/or carboxylated-diamine moieties and the polyalkylene oxide moieties. As noted in preparing the pre-polymer, with an excess of isocyanate groups and with the reaction with water, the polyethylene particles also include isocyanate-generated amine groups as well. Next, more water can be added and solvent can be removed by vacuum distillation in some examples, thus, suspending the polyurethane particles in a higher concentration of water. With specific reference to the sulfonated- and/or carboxylated diamine moieties, some may participate in intra-polymer or inter-polymer crosslinking, and some may not participate in crosslinking. Thus, even with some sulfonated- and/or carboxylated diamine moieties not participating in crosslinking, the grafted side chains provided by the PPO and/or PEO moieties can provide protection to the sulfonate and/or carboxylate groups, inhibiting their interaction with any salt or cationic polymer that may be present therewith as a fixing agent, for example.

An example preparation scheme is shown in Table 1, which sets for various steps in one example sequence, as follows:

TABLE 1

| Step | | |
|---|---|---|
| 1 | Initial Reactants | Diisocyanate + polymeric diol + nonionic |
| | | aliphatic diol + catalyst/acetone → |
| 2 | Prepolymer | Formation backbone including excess |
| | | isocyanate groups and urethane linkages |
| | | generated from polymeric diols and |
| | | nonionic aliphatic diols |
| 3 | Polyalkylene | OH-PEO and/or OH-PPO → |
| | Oxide | |
| | Alcohol | |
| | Reactant | |
| 4 | Intermediate | Prepolymer modified with polyalkylene |
| | Polymer | pendant groups attached via urethane |
| | | linkages with excess isocyanate |
| | | groups remaining |
| 5 | Acid-Diamine | Sulfonated- or |
| | Reactant | carboxylated-diamine groups → |
| 6 | Acidified | Intermediate polymer modified |
| | Polymer | with sulfonated- or carboxylated-diamine |
| | | groups with excess isocyanate |
| | | groups remaining |
| 7 | Aqueous | Water (remove acetone) → |
| | Dispersion | |
| 8 | Polyurethane | Polyurethane particle dispersion |
| | Particles | including sulfonated- or carboxylated-diamine |
| | Dispersed | groups, isocyanate-generated amine |
| | in Water | groups, and polyalkylene oxide side-chains |

Notably, the excess isocyanate groups can be converted to the isocyanate-generated amine groups at any of the stages shown in Table 1 above when there is water for the reaction. Any of the isocyanate groups that may be still be present when water is added would at that point be converted to the isocyanate-generated amine groups. These amine groups can be available for crosslinking, for example.

FIG. 4 provides example portions of polyurethane particles that can be formed, for example in accordance with the preparative scheme of Table 1 or other similar reaction scheme. This FIG. does not show the cross-linking, but rather shows the types of groups or moieties that can be present along the polymer of the polyurethane particles, some of which can be available for internal crosslinking. In FIG. 4, the polyurethane polymer portions shown identify several urethane linkage groups (410), urea groups (420), acid groups (sulfonic acid or carboxylic acid) (430) of example acid-diamines (480) (sulfonated- or carboxylated-diamines), polymerized polymeric diols (440), and polymerized nonionic aliphatic diols (450). Notably, the polymerized polymeric diols and the polymerized nonionic aliphatic diols liberate hydrogens at their hydroxyl moieties to form the urethane linkage groups in some locations. As shown also in FIG. 4, polymerized diisocyanates (460) are also shown, which include urethane linkage groups on either side of a central moiety, with the central moiety being generically as a circle. The central moiety of the polymerized diisocyanates may be provided from any of the diisocyanates shown and/or described herein, or any of a number of other diisocyanates, or can also be representative of multiple different types of diisocyanates used in combination. Thus, the central moieties (shown as a circle) from the diisocyanates can actually be different at the various locations where this central moiety, or circle, is shown in FIG. 4. As another example, there can also be other types of compounds included in the polymerized polyurethane particles beyond that which is shown in Table 1. For example, one of the polyurethane particle portions identifies an example polymerized organic acid diol (470), which is generated from an organic acid diol, e.g., 2,2-bis(hydroxymethyl)propionic acid in this instance. This can be added when generating the prepolymer with the other diols, for example. If an organic acid diol is used, it can be used in addition to the polymeric diol and/or the nonionic aliphatic diol previously described, thus providing a carboxylate group coupled directly to a polymer backbone of the polyurethane polymer in addition to the polymeric or oligomeric portions provided by the polymeric diol. Also shown is an isocyanate-generated amino group (480). This can be generated from any excess isocyanate groups, such as those not otherwise used for other types of polymer modification, e.g., appending acidic-diamines and/or polyalkylene oxides to the polymer. Thus, in examples of the present disclosure, the polyurethane polymer can be self-crosslinked, self-crosslinkable, can include a sulfonated- or carboxylated-diamine, a nonionic aliphatic diol, and an isocyanate-generated amine group, e.g., isocyanate-generated amino group. Other groups may also be present, such as a polymerized organic acid diol, for example. In some examples, it is noted that the isocyanate-generated amine group shown can further react with isocyanates to form additional urethane bonds for crosslinking reactions. However, there can also be amino groups or secondary amines present that remain available for additional crosslinking to print media substrates, printed ink components, etc.

In more specific detail regarding the initial reactants and then additional reactants that can be used in forming the polyurethane particles, example diisocyanates that can be used to prepare the pre-polymer include 2,2,4 (or 2, 4, 4)-trimethylhexane-1,6-diisocyanate (TMDI), hexamethylene diisocyanate (HDI), methylene diphenyl diisocyanate (MDI), isophorone diisocyanate (IPDI), and/or 1-Isocyanato-4-[(4-isocyanatocyclohexyl)methyl]cyclohexane (H12MDI), etc., or combinations thereof, as shown below. Others can likewise be used alone, or in combination with these diisocyanates, or in combination with other diisocyanates not shown.

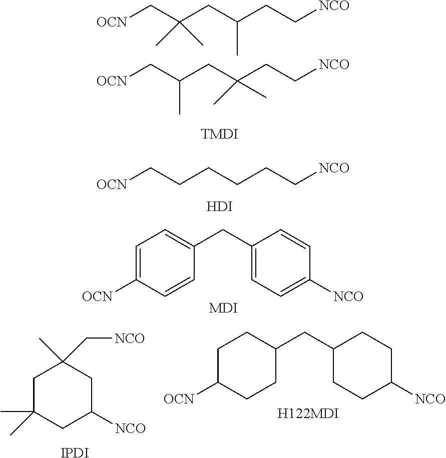

In further detail, there are also polymeric diols as well as small molecular nonionic aliphatic diols that can be used in preparing the polyurethane particles of the present disclosure. Example polymeric diol include polyester diols or a polycarbonate diols, for example. Other polymeric diols that can be used include polyether diols, or even combination diols, such as a combination that could be used to form a polycarbonate ester polyether-type polyurethane. In one specific example, however, the polyurethane particles can include polyester polyurethane moieties.

Regarding the nonionic aliphatic diols, these can typically be small molecular diols, e.g., up to an atomic mass of about 300 or defined as having from 2 to 16 carbon atoms and can be included in addition to the polymeric diols described above. The nonionic aliphatic diols of the present disclosure can be included in the polyurethane particles, providing additional chain extension of polyurethane dispersions. Examples of nonionic aliphatic diols that can be used include various alkyl and/or alicyclic diols, including those shown as follows:

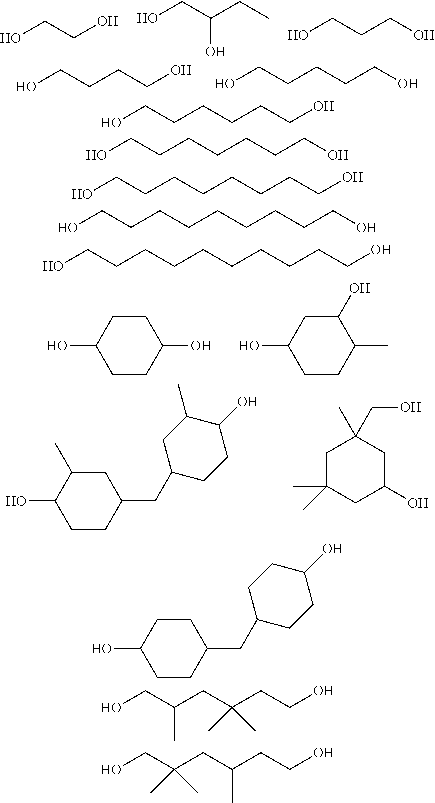

Thus, in some examples, nonionic aliphatic diols can be selected from the group consisting of 1,5-butanediol; 1,2-butanediol; 1,3-propanediol; 1,7-heptanediol; 1,8-octanediol; 1,10-decanediol; 1,5-pemtanediol; 4,4′-methylenebis[2-methyl-cyclohexanol]; 4-methyl-1,3-cyclohexanediol; 4,4′-methylenebis-cyclohexanol; 5-hydroxy-1,3,3-trimehylcyclohexanemethanol; 2,2,4-trimethyl-1,6-hexanediol; ethylene glycol; 1,4-cyclohexanediol and 1,6-hexanediol.

Once the pre-polymer is formed, the polyurethane particles can be generated to include the polyalkylene oxide groups as well as the sulfonated- or carboxylated-diamine groups appended on to the polyurethane polymer backbone. As also previously noted, with an excess of isocyanate groups and the presence or introduction of water, the polyethylene particles can also include isocyanate-generated amine groups as well.

With more specific reference to the polyalkylene oxide moieties that can be included, these can be grafted onto the polymer backbone by reacting the pre-polymer with mono-substituted polyalkylene oxide alcohol, such as polyethylene oxide (PEO) alcohol and/or polypropylene oxide (PPO) alcohol, for example. The polyalkylene oxide side-chains that are added or grafted to the polymer backbone can have a number average molecular weight from 500 Mn to 15,000 Mn, from 1,000 Mn to 12,000 Mn, from 2,000 Mn to 10,000 Mn, or from 3,000 Mn to 8,000 Mn, for example. Within these ranges of repeating C2-C3 alkyl oxide groups, polypropylene oxide groups can provide greater weight average molecular weight to the side-chain compared to polyethylene oxide, as there are three carbons present per oxygen compare to two carbons per oxygen. In some examples the polyalkylene oxide side-chains can also be a combination of both C2 alkyl oxide groups and C3 alkyl oxide groups. In connection with the sulfonated- and/or carboxylated diamine moieties, some may participate in intra-polymer or inter-polymer crosslinking, and some may not participate in crosslinking. However, even when some sulfonated- and/or carboxylated diamine moieties do not participate in crosslinking, the grafted side chains provided by the PPO and/or PEO moieties can provide protection to the sulfonate and/or carboxylate groups, inhibiting their interaction with any salt or cationic polymer that may be present therewith as a fixing agent, for example.

With respect to the sulfonated- or carboxylated-diamines that can be used in forming the polyurethane particles as described herein, they can be prepared from any of a number of diamine compounds by adding carboxylate or sulfonate groups thereto. Example diamines can include various dihydrazides, alkyldihydrazides, sebacic dihydrazides, alkyldioic dihydrazides, aryl dihydrazides, e.g., terephthalic dihydrazide, organic acid dihydrazide, e.g., succinic dihydrazides, adipic acid dihydrazides, etc, oxalyl dihydrazides, azelaic dihydrazides, carbohydrazide, etc. Example diamine structures are shown below, with some specific examples of diamines including 4,4′-methylenebis(2-methylcyclohexyl-amine) (DMDC), 4-methyl-1,3′-cyclohexanediamine (HTDA), 4,4′-Methylenebis(cyclohexylamine) (PACM), isophorone diamine (IPDA), tetramethylethylenediamine (TMDA), ethylene diamine (DEA), 1,4-cyclohexane diamine, 1,6-hexane diamine, hydrazine, adipic acid dihydrazide (AAD), carbohydrazide (CHD), and/or diethylene triamine (DETA), notably, DETA includes three amine groups, and thus, is a triamine. However, since it also includes two amines, it is considered to fall within the definition herein of “diamine,” meaning it includes two amine groups. Many of the diamine structures shown below can be used to form the sulfonated- or carboxylated diamine, and thus are shown by way of example below:

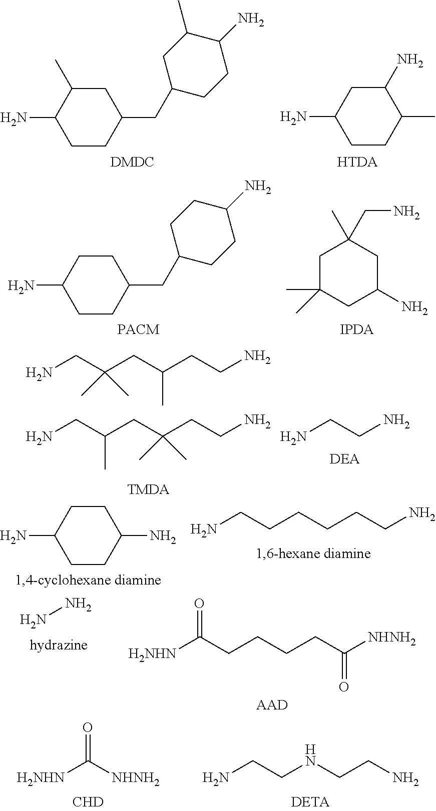

There are also other alkyl diamines (other than 1,6-hexane diamine) that can be used, such as, by way of example:

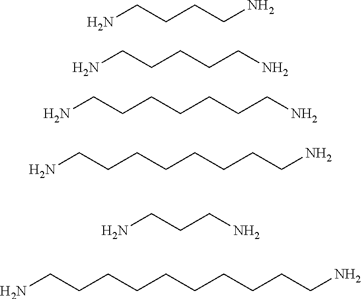

There are also other dihydrazides (other than AAD shown above) that can be used, such as, by way of example:

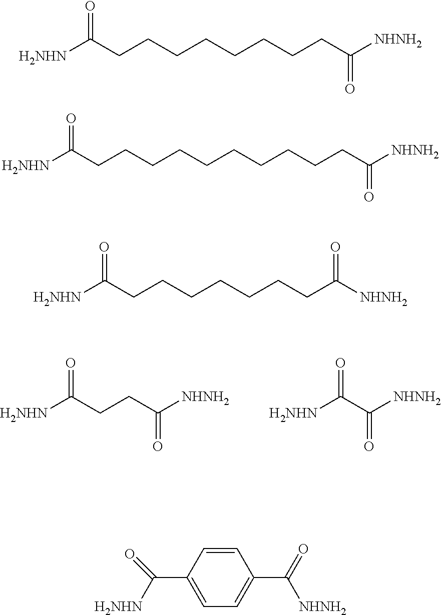

In some examples, the coating composition, that will form the image-receiving layer, can further comprise colorant fixation agent also called herein fixing agent. Thus, in accordance with examples of the present disclosure, a fixing agent can be included in the coating composition and on the coated media substrate. The fixing agent can be any species of chemical compounds which carry multiple positive charge center. For metal salts with one metal, the multiple positive charges can be found in a single multivalent metal, or for salts with multiple metals, the multiple positive charge centers can be from multiple monovalent and/or divalent metals.

When present, the fixing agent can include metal inorganic salt, metal organic salt, cationic polymer, or a combination thereof. In some other examples, the fixing agent is cationic polymer including an alkylated quaternary polyamine cationic polymer or an ionene cationic polymer. In some examples, when present, the fixing agent is present in the coating composition in an amount representing between 1% and 30% of the total weight of the coating composition. In some other examples, the fixing agent are present in the coating composition in an amount representing between 2% and 20% of the total weight of the coating composition. In yet some other examples, the fixing agent are present in the coating composition in an amount representing between 5% and 15% of the total weight of the coating composition.

In some other examples, the fixing agent can be cationic polymer, and the polyurethane particles and the cationic polymer are present at a weight ratio from 2:1 to 20:1.

In one example, the fixing agent can be selected from inorganic multivalent metallic salts, such as Group II metals or Group III metals. Example cationic transition metals that can be used include, without limitation, calcium, copper, nickel, magnesium, zinc, barium, iron, aluminum, chromium, or a combination thereof. Example anionic species that can be used include chloride, iodide, bromide, nitrate, sulfate, sulfite, phosphate, chlorate, acetate, or combinations thereof.

In another example, the fixing agent can be selected from the organic metallic salts. Organic metallic salt are ionic compounds composed of cations and anions with a formula such as (CₙH₂₊₁COO⁻M⁺)*(H₂O)ₘ, where M⁺ is cation species including Group I metals, Group II metals, or Group III metals, for example. Transition metals and other monovalent metals that can be used include, for example, sodium, potassium, calcium, copper, nickel, zinc, magnesium, barium, iron, aluminum, chromium, or a combination thereof. Anion species can include any negatively charged carbon species with a value of n from 1 to 35. The hydrates (H₂O) are water molecules attached to salt molecules with a value of m from 0 to 20. Examples of water-soluble salts include, but are not limited to, calcium acetate monohydrate, calcium propionate, calcium propionate hydrate, calcium formate, etc.

Further, in other examples, fixing agent can be a cationic polymer with multiple charge centers. Cationic polymer may have cationic groups as part of the main chain (polymer backbone) or as part of an appended side-chain (pendent group). In one example, the cationic polymer can be a naturally occurring polymer such as cationic gelatin, cationic dextran, cationic chitosan, cationic cellulose, cationic cyclodextrin, etc. The cationic polymer can also be a synthetically modified naturally occurring polymer such as a modified chitosan, e.g., carboxymethyl chitosan, N, N, N-trimethyl chitosan chloride, etc. In one specific example, the cationic polymer can be a polymer having cationic groups as part of the main chain, such as an alkoxylated quaternary polyamine having the structure of Formula II, as follows:

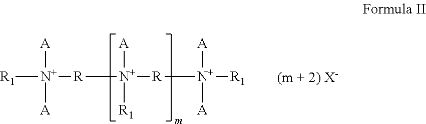

where R, R₁ and A can be the same group or different groups, such as linear or branched C₂-C₁₂ alkylene, C₃-C₁₂ hydroxyalkylene, C₄-C₁₂ dihydroxyalkylene, or dialkylarylene; X can be any suitable counter ion, such as halogen, chloride, bromide, iodide, etc., or other similarly charged anions; and m can be a numeral suitable to provide a polymer having a weight average molecular weight ranging from 100 Mw to 8000 Mw. In this example, the nitrogen atoms along the backbone can be quaternized. Formula II relates to the various commercial products with the trade name Floquat™, which are cationic polymers available from SNF (UK) Ltd., United Kingdom.

In another example, an ionene polymer can used, which is a polymer having ionic groups that are appended to the backbone unit as a side-chain, with an example including quaternized poly(4-vinyl pyridine), having the structure of Formula III, as follows:

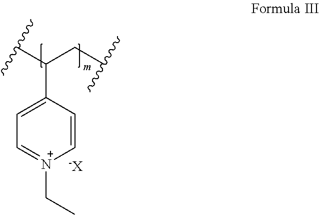

Again, in this example, X can be any suitable counter ion, such as halogen, chloride, bromide, iodide, etc., or other similarly charged anions; and m can be a numeral suitable to provide a polymer having a weight average molecular weight ranging from 100 Mw to 8000 Mw.

In yet another example, the cationic polymer can include polyamines and/or a salts thereof, polyacrylate diamines, quaternary ammonium salts, polyoxyethylenated amines, quaternized polyoxyethylenated amines, polydicyandiamides, polydiallyldimethyl ammonium chloride polymeric salts, or quaternized dimethylaminoethyl(meth)acrylate polymers. In another example, the cationic polymer can include polyimines and/or salts thereof, such as linear polyethyleneimines, branched polyethyleneimines, or quaternized polyethylenimines. In another example, the ionene polymer can include a substitute polyurea such as poly[bis(2-chloroethyl)ether-alt-1,3 bis[3-(dimethylamino)propyl]urea], or quaternized poly[bis(2 chloroethyl)ether-alt-1,3-bis [3-(dimethylamino)propyl]. In another example, the cationic polymer can be a vinyl polymer and/or a salt thereof, such as quaternized vinyl imidazol polymers, modified cationic vinyl alcohol polymers, or alkyl guanidine polymers.

In addition to the fixing agent, the coating composition and coating present on the coated media substrate can also include particulate fillers. Examples can include inorganic pigment(s), such as white inorganic pigments if the media is intended to be white, for example. Examples of inorganic pigments that may be used include, but are not limited to, aluminum silicate, kaolin clay, a calcium carbonate, silica, alumina, boehmite, mica and talc, and combinations or mixtures thereof. In some examples, the inorganic pigment includes a clay or a clay mixture. In some examples, the inorganic pigment includes a calcium carbonate or a calcium carbonate mixture. The calcium carbonate may be one or more of ground calcium carbonate (GCC), precipitated calcium carbonate (PCC), modified GCC, and modified PCC, for example. For example, the inorganic pigment may include a mixture of a calcium carbonate and a clay. The particulate fillers can have average particle size ranged from 0.1 μm to 10 μm, with a dry weight ratio of polyurethane particles to particulate filler ranging from 100:1 to 1:20, from 50:1 to 10:1, from 20:1 to 5:1, or from 10:1 to 1:1, for example. A specific example of a particulate filler that can be used is NuCap®, which is available from Kamin, LLC, USA.

In some examples, there are other additives that can be used or included, such as coating composition thickener, such as Tylose® HS-100K, available from SE Tylose GmbH & Co. KG, Germany. Surfactant, such as Pluronic L61, available from BASF SE, Germany, can also be included. Other commercially-available surfactant that can be used includes the TAMOL™ series from Dow Chemical Co., nonyl and octyl phenol ethoxylates from Dow Chemical Co. (e.g., Triton™ X-45, Triton™ X-100, Triton™ X-114, Triton™ X-165, Triton™ X-305 and Triton™ X-405) and other suppliers (e.g., the T-DET™ N series from Harcros Chemicals), alkyl phenol ethoxylate (APE) replacements from Dow Chemical Co., Elementis Specialties, and others, various members of the Surfynol® series from Air Products and Chemicals, (e.g., Surfynol® 104, Surfynol® 104A, Surfynol® 104BC, Surfynol® 104DPM, Surfynol® 104E, Surfynol® 104H, Surfynol® 104PA, Surfynol® 104PG50, Surfynol® 104S, Surfynol® 2502, Surfynol® 420, Surfynol® 440, Surfynol® 465, Surfynol® 485, Surfynol® 485W, Surfynol® 82, Surfynol® CT-211, Surfynol® CT-221, Surfynol® OP-340, Surfynol® PSA204, Surfynol® PSA216, Surfynol® PSA336, Surfynol® SE and Surfynol® SE-F), Capstone® FS-35 from DuPont, various fluorocarbon surfactants from 3M, E.I. DuPont, and other suppliers, and phosphate esters from Ashland, Rhodia and other suppliers. Dynwet® 800, for example, from BYK-chemie, Gmbh (Germany), can also be used.

In this disclosure, a method of using such coating composition onto a media base substrate is disclosed. Said composition can be used as a coating composition for a fabric media substrate. The resulting coated printing media will show excellent image quality and durability on inkjet printing, especially latex based inkjet printing, while maintains good flame retardancy. In some examples, the coating composition described herein, can be applied to fabric-based substrate; when applied it will form a coating layer that can be called and that can form an image-receiving coating layer. In some other examples, the coating composition described herein, can be applied to fabric-based substrate, when applied it will form a coating layer that can be called and that can form an image-receiving coating layer. Such image-receiving coating layer can be applied to at least, one side of the substrate. In some examples, the image-receiving coating layer can be applied to both opposing side of the substrate.

The present disclosure relates thus also to a coated printable medium, with an image-side (101) and a back-side (102), comprising a base substrate (110) and a coating composition applied over, at least, one side of the base substrate, forming an image-receiving layer (120), and comprising water, water-soluble cationic phosphonium salts and polyurethane particles including sulfonated- or carboxylated-diamine groups, isocyanate-generated amine groups, and polyalkylene oxide side-chains. In some other examples, the base substrate is a fabric-based substrate.

The coating composition that comprises water, water-soluble cationic phosphonium salts and polyurethane particles including sulfonated- or carboxylated-diamine groups, isocyanate-generated amine groups, and polyalkylene oxide side-chains can be applied to a printable medium (100) in order to form an image-receiving layer (120). Such layer would act as the image-receiving layer since, during the printing process, the ink will be directly deposited on its surface. The coated printable medium (100) of the present disclosure, that can also be called herein printable recording media, is a media that comprises a base substrate (110). The base substrate (110) can also be called bottom supporting substrate or fabric substrate. The word “supporting” also refers to a physical objective of the substrate that is to carry the coatings layer and the image that is going to be printed. In some examples, the coated printable medium (100) of the present disclosure, is a fabric printable recording media, meaning that the base substrate (110) is a fabric-based substrate.

The coating compositions, coated print media, and methods of coating print media described herein can be suitable for use with textile of fabric media print substrate (110). In one example, textiles or fabrics can be treated with the coating compositions of the present disclosure, including cotton fibers, treated and untreated cotton substrates, polyester substrates, nylons, blended substrates thereof, etc.

The term “fabric” can be used to mean a textile, a cloth, a fabric material, fabric clothing, or another fabric product. The term “fabric structure” is intended to mean a structure having warp and weft that is woven, non-woven, knitted, tufted, crocheted, knotted, and/or pressured, for example. The terms “warp” and “weft” refer to weaving terms that have their ordinary means in the textile arts, as used herein, e.g., warp refers to lengthwise or longitudinal yarns on a loom, while weft refers to crosswise or transverse yarns on a loom.

Additionally, fabric substrate useful in the present disclosure can include fabric substrates that have fibers that can be natural and/or synthetic. It is notable that the term “fabric substrate” does not include materials commonly known as any kind of paper (even though paper can include multiple types of natural and synthetic fibers or mixture of both types of fibers). Furthermore, fabric substrates include both textiles in its filament form, in the form of fabric material, or even in the form of fabric that has been crafted into finished article (clothing, blankets, tablecloths, napkins, bedding material, curtains, carpet, shoes, etc.). In some examples, the fabric substrate has a woven, knitted, non-woven, or tufted fabric structure.

The fabric substrate can be a woven fabric where warp yarns and weft yarns are mutually positioned at an angle of about 90°. This woven fabric can include, but is not limited to, fabric with a plain weave structure, fabric with a twill weave structure where the twill weave produces diagonal lines on a face of the fabric, or a satin weave. The fabric substrate can be a knitted fabric with a loop structure including one or both of warp-knit fabric and weft-knit fabric. The weft-knit fabric refers to loops of one row of fabric are formed from the same yarn. The warp-knit fabric refers to every loop in the fabric structure that is formed from a separate yarn mainly introduced in a longitudinal fabric direction. The fabric substrate can also be a non-woven product, for example a flexible fabric that includes a plurality of fibers or filaments that are bonded together and/or interlocked together by a chemical treatment process (e.g., a solvent treatment), a mechanical treatment process (e.g., embossing), a thermal treatment process, or a combination of two or more of these processes.

The fabric substrate can include one or both of natural fibers and synthetic fibers. Natural fibers that can be used include, but are not limited to, wool, cotton, silk, linen, jute, flax or hemp. Additional fibers that can be used include, but are not limited to, rayon fibers, or those of thermoplastic aliphatic polymeric fibers derived from renewable resources, including, but not limited to, corn starch, tapioca products, or sugarcanes. These additional fibers can be referred to as “natural” fibers. In some examples, the fibers used in the fabric substrate includes a combination of two or more from the above-listed natural fibers, a combination of any of the above-listed natural fibers with another natural fiber or with synthetic fiber, a mixture of two or more from the above-listed natural fibers, or a mixture of any thereof with another natural fiber or with synthetic fiber.

Synthetic fibers that can be used in the fabric substrate can include polymeric fibers such as, but not limited to, polyvinyl chloride (PVC) fibers, polyvinyl chloride (PVC)-free fibers made of polyester, polyamide, polyimide, polyacrylic, polypropylene, polyethylene, polyurethane, polystyrene, polyaramid, e.g., Kevlar®, polytetrafluoroethylene, e.g., Teflon® (both trademarks of E. I. du Pont de Nemours and Company), fiberglass, polytrimethylene, polycarbonate, polyester terephthalate, or polybutylene terephthalate. In some examples, the fiber used in the fabric substrate can include a combination of two or more fiber materials, a combination of a synthetic fiber with another synthetic fiber or natural fiber, a mixture of two or more synthetic fibers, or a mixture of synthetic fibers with another synthetic or natural fiber. In some examples, the synthetic fiber can include a modified fiber. The term ‘modified fiber’ can refer to one or both of the synthetic fiber and the fabric substrate as a whole having undergone a chemical or physical process such as, but not limited to, one or more of a copolymerization with monomers of other polymers, a chemical grafting reaction to contact a chemical functional group with one or both the synthetic fiber and a surface of the fabric, a plasma treatment, a solvent treatment, for example acid etching, and a biological treatment, for example an enzyme treatment or antimicrobial treatment to prevent biological degradation. The term “PVC-free” means no polyvinyl chloride (PVC) polymer or vinyl chloride monomer units in the substrate. In some examples, the fabric base substrate is a synthetic polyester fiber.

The fabric substrate can include both natural fibers and synthetic fibers. In some examples, the amount of synthetic fibers represents from about 20 wt % to about 90 wt % of the total amount of fibers. In some other examples, the amount of natural fibers represents from about 10 wt % to about 80 wt % of the total amount of fibers. In some other examples, the fabric substrate includes natural fibers and synthetic fibers in a woven structure, the amount of natural fibers is about 10 wt % of a total fiber amount and the amount of synthetic fibers is about 90 wt % of the total fiber amount. In some examples, the fabric substrate can also include additives such as, but not limited to, one or more of colorant (e.g., pigments, dyes, tints), antistatic agents, brightening agents, nucleating agents, antioxidants, UV stabilizers, fillers, lubricants, and combinations thereof.

The fabric substrate can have a basis weight ranging from 50 gsm to 400 gsm.

The printable medium (100) of the present disclosure comprises a base substrate (110) and an image-receiving coating layer (120) applied over, at least, one side of the base substrate. The image-receiving coating layer is made of the coating composition described herein; i.e. that comprises water, water-soluble cationic phosphonium salts and polyurethane particles including sulfonated- or carboxylated-diamine groups, isocyanate-generated amine groups, and polyalkylene oxide side-chains.

In some examples, the composition described is applied to an “uncoated” substrate. By “uncoated”, it is meant herein that the media substrate has not been treated or coated by any composition and that the pre-treatment composition is applied directly of the substrate that constitute the media.

The coating composition of the present disclosure or the image-receiving coating composition can be applied at a dry coat-weight ranging from about 0.1 to about 40 gsm (gram per square meter) or at a coat-weight ranging or from about 1 to 20 gsm (gram per square meter) or at a coat-weight ranging or from about 2 to 10 gsm (gram per square meter) to a media base substrate in order to form an image-receiving layer (120). In some other examples, the image-receiving coating composition is applied to the primary layer at a thickness ranging from about 1 μm to about 50 μm with a dry coat-weight ranging from about 1 gsm to about 20 gsm to a media base substrate in order to form an image-receiving layer (120). In one example, when present, the primary layer (120) can be applied to the base substrate at a dry coat-weight ranging from about 1 gsm to about 80 gsm per side. In one other example, the primary layer (120) is applied, to the substrate, at a dry coat-weight ranging from about 5 gsm to about 60 gsm. In yet another example, the primary layer (120) is applied, to the substrate, at a dry coat-weight ranging from about 10 gsm to about 40 gsm.

The printable medium, described herein, is prepared by using several surface treatment compositions herein named a coating layer or coating composition. A method of making a coated print medium includes applying a coating composition as a layer to a media substrate and drying the coating composition to remove water from the media substrate to leave an ink-receiving layer thereon. The coating composition includes water and polyurethane particles including cationic triphenyl-phosphonium salt functional groups.

In some examples, as illustrated in FIG. 3, the method (200) method of making a coated printable medium encompasses: applying a coating composition as a layer to a media substrate, the coating composition including water, water-soluble cationic phosphonium salts and polyurethane particles including sulfonated- or carboxylated-diamine groups, isocyanate-generated amine groups, and polyalkylene oxide side-chains (210); drying the coating composition to remove water from the media substrate to leave an ink-receiving layer thereon (220). In some examples, the media substrate is a fabric media substrate.

When applying the coating composition to a media substrate, the coating composition can be applied to any media substrate type using any method appropriate for the coating application properties, e.g., thickness, viscosity, etc. Non-limiting examples of methods include size press, slot die, blade coating, Meyer rod coating and padding coating. In another example, a two rolls padding coating is used to apply the coating composition to a fabric substrate (or other type of substrate). Subsequently, when the coating composition is dried, it can form an ink-receiving layer. Drying can be by air drying, heated airflow drying, baking, infrared heated drying, etc. Other processing methods and equipment can also be used. For one example, the coated media substrate can be passed between a pair of rollers, as part of a calendering process, after drying. The calendering device can be any kind of calendaring apparatus, including but not limited to off-line super-calender, on-line calender, soft-nip calender, hard-nip calender, or the like.

In further detail and by way of example, the ink-receiving layer can be formed on a media substrate with a dried coating weight from 0.5 grams/m2 (gsm) to 20 gsm, from 4 gsm to 18 gsm, from 5 gsm to 15 gsm, or from 6 gsm to 12 gsm. The coatings of the present disclosure can be applied with acceptable smoothness, as well to provide the ability of the coated media to absorb ink or to evenly distribute ink colorant, e.g., pigment. Furthermore, the coating composition, when applied to a media substrate as a coating there can act to favorably have an impact on media opacity, brightness, whiteness, glossiness, and/or surface smoothness of image-receiving layer in some examples.

The image-receiving coating layer (120) can be dried using any drying method in the arts such as box hot air dryer. The dryer can be a single unit or could be in a serial of 3 to 7 units so that a temperature profile can be created with initial higher temperature (to remove excessive water) and mild temperature in end units (to ensure completely drying with a final moisture level of less than 3-7% for example). The peak dryer temperature can be programmed into a profile with higher temperature at begging of the drying when wet moisture is high and reduced to lower temperature when web becoming dry. The dryer temperature is controlled to a temperature of less than about 200° C. to avoid yellowing textile, and the fabric web temperature is controlled in the range of about 90 to about 150° C. In some examples, the operation speed of the coating/drying line is 20 to 30 meters per minute.

Once the coating compositions are applied to the base substrate and appropriately dried, ink compositions can be applied by any processes onto the printable medium. In some examples, the ink composition is applied to the printable medium via inkjet printing techniques. A printing method could encompasses obtaining a coated printable medium as defined herein and applying an ink composition onto said fabric printable medium to form a printed image. Said printed image will have, for instance, enhanced image quality and image permanence. In some examples, when needed, the printed image can be dried using any drying device attached to a printer such as, for instance, an IR heater.

In some examples, the ink composition is an inkjet ink composition that contains one or more colorants that impart the desired color to the printed message and a liquid vehicle. As used herein, “colorant” includes dyes, pigments, and/or other particulates that may be suspended or dissolved in an ink vehicle. The colorant can be present in the ink composition in an amount required to produce the desired contrast and readability. In some examples, the ink compositions include pigments as colorants. Pigments that can be used include self-dispersed pigments and non-self-dispersed pigments. Any pigment can be used; suitable pigments include black pigments, white pigments, cyan pigments, magenta pigments, yellow pigments, or the like. Pigments can be organic or inorganic particles as well known in the art. As used herein, “liquid vehicle” is defined to include any liquid composition that is used to carry colorants, including pigments, to a substrate. A wide variety of liquid vehicle components may be used and include, as examples, water or any kind of solvents.

In some other examples, the ink composition, applied to the printable medium, is an ink composition containing latex components. Latex components are, for examples, polymeric latex particulates. The ink composition may contain polymeric latex particulates in an amount representing from about 0.5 wt % to about 15 wt % based on the total weight of the ink composition. The polymeric latex refers herein to a stable dispersion of polymeric micro-particles dispersed in the aqueous vehicle of the ink. The polymeric latex can be natural latex or synthetic latex. Synthetic latexes are usually produced by emulsion polymerization using a variety of initiators, surfactants and monomers. In various examples, the polymeric latex can be cationic, anionic, nonionic, or amphoteric polymeric latex. Monomers that are often used to make synthetic latexes include ethyl acrylate; ethyl methacrylate; benzyl acrylate; benzyl methacrylate; propyl acrylate; methyl methacrylate, propyl methacrylate; iso-propyl acrylate; iso-propyl methacrylate; butyl acrylate; butyl methacrylate; hexyl acrylate; hexyl methacrylate; octadecyl methacrylate; octadecyl acrylate; lauryl methacrylate; lauryl acrylate; hydroxyethyl acrylate; hydroxyethyl methacrylate; hydroxyhexyl acrylate; hydroxyhexyl methacrylate; hydroxyoctadecyl acrylate; hydroxyoctadecyl methacrylate; hydroxylauryl methacrylate; hydroxylauryl acrylate; phenethyl acrylate; phenethyl methacrylate; 6-phenylhexyl acrylate; 6-phenylhexyl methacrylate; phenyllauryl acrylate; phenyllauryl methacrylate; 3-nitrophenyl-6-hexyl methacrylate; 3-nitrophenyl-18-octadecyl acrylate; ethyleneglycol dicyclopentyl ether acrylate; vinyl ethyl ketone; vinyl propyl ketone; vinyl hexyl ketone; vinyl octyl ketone; vinyl butyl ketone; cyclohexyl acrylate; methoxysilane; acryloxy-propyhiethyl-dimethoxysilane; trifluoromethyl styrene; trifluoromethyl acrylate; trifluoromethyl methacrylate; tetrafluoropropyl acrylate; tetrafluoropropyl methacrylate; heptafluorobutyl methacrylate; butyl acrylate; iso-butyl methacrylate; 2-ethylhexyl acrylate; 2-ethylhexyl methacrylate; isooctyl acrylate; and iso-octyl methacrylate.

In some examples, the latexes are prepared by latex emulsion polymerization and have an average molecular weight ranging from about 10,000 Mw to about 5,000,000 Mw. The polymeric latex can be selected from the group consisting of acrylic polymers or copolymers, vinyl acetate polymers or copolymers, polyester polymers or copolymers, vinylidene chloride polymers or copolymers, butadiene polymers or copolymers, polystyrene polymers or copolymers, styrene-butadiene polymers or copolymers and acrylonitrile-butadiene polymers or copolymers. The latex components are on the form of a polymeric latex liquid suspension. Such polymeric latex liquid suspension can contain a liquid (such as water and/or other liquids) and polymeric latex particulates having a size ranging from about 20 nm to about 500 nm or ranging from about 100 nm to about 300 nm.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “acid value” or “acid number” refers to the mass of potassium hydroxide (KOH) in milligrams that can be used to neutralize one gram of substance (mg KOH/g), such as the polyurethane disclosed herein. This value can be determined, in one example, by dissolving or dispersing a known quantity of a material in organic solvent and then titrating with a solution of potassium hydroxide (KOH) of known concentration for measurement.

“Glass transition temperature” or “Tg,” can be calculated by the Fox equation: copolymer Tg=1/(Wa/(Tg A)+Wb(Tg B)+ . . . ) where Wa=weight fraction of monomer A in the copolymer and TgA is the homopolymer Tg value of monomer A, Wb=weight fraction of monomer B and TgB is the homopolymer Tg value of monomer B, etc. With polyurethane, the hard segments and soft segments can be used to calculate the glass transition temperature of the polymer with the hard and soft segments being calculated based on the various segments used as the homopolymer for the calculation.

“D50” particle size is defined as the particle size at which about half of the particles are larger than the D50 particle size and about half of the other particles are smaller than the D50 particle size (by weight based on the metal particle content of the particulate build material). As used herein, particle size with respect to the polyurethane particles can be based on volume of the particle size normalized to a spherical shape for diameter measurement, for example. Particle size can be collected using a Malvern Zetasizer, for example. Likewise, the “D95” is defined as the particle size at which about 5 wt % of the particles are larger than the D95 particle size and about 95 wt % of the remaining particles are smaller than the D95 particle size. Particle size information can also be determined and/or verified using a scanning electron microscope (SEM).

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Synthesis of Polyurethane Particles—PUB 1

65.797 grams of polyester diol (Stepanpol® PC-1015-55, from Stepan Company, USA), 22.977 grams of isophorone diisocyanate (IPDI), 3.440 grams of 1,4-butanediol, and 64 grams of acetone were mixed in a 500 mL of 4-neck round bottom flask. A mechanical stirrer with glass rod and Teflon blade was attached. A condenser was also attached. The flask was immersed in a constant temperature bath at 75° C. The system was kept under drying tube. Three (3) drops of dibutyltin dilaurate (DBTDL) was added to initiate the polymerization. Polymerization was continued for 3 hours at 75° C. 0.5-gram samples was withdrawn for wt % NCO titration to confirm the reaction. 4.082 grams of poly(ethylene oxide) methyl ether (Mn=2,000) in 10 grams of acetone was added to the reactor. The polymerization was continued 3 hours at 75° C. 0.5 g of pre-polymer was withdrawn for final wt % NCO titration. The measured NCO value was 2.78 wt %. The theoretical wt % NCO should be 2.79 wt %. The polymerization temperature was reduced to 50° C. 7.368 grams of sodium 2-[(2-aminoethyl)amino]ethanesulfonate (Vestamin® A-95, 50% in water, from Evonik, Germany) in 213.183 grams of DI water was added over 30 minutes. The solution became milky and white color and the milky dispersion was continued to stir for overnight at room temperature. The PUB dispersion was filtered through 400 mesh stainless sieve. Acetone was removed with rotorvap at 50° C. (add 2 drops (20 mg) BYK-011 de-foaming agent, from Byk Additives Ltd., United Kingdom). The final PUB dispersion was filtered through fiber glass filter paper. Particle size measured by Malvern Zetasizer is 178.7 nm; pH was 8.0; and solid content was 28.28 wt %.

### Example 2—Preparation of Polyurethane Particles PUB 2

66.624 grams of grams of polyester diol (Stepanpol® PC-1015-55), 22.028 grams of a mixture of 2,2,4-trimethylhexamethylene diisocyanate and 2,4,4-trimethylhexamethylene diisocyanate (TMDI), 3.484 grams of 1,4-butanediol and 64 grams of acetone were mixed in a 500 mL of 4-neck round bottom flask. A mechanical stirrer with glass rod and Teflon blade was attached. A condenser was attached. The flask was immersed in a constant temperature bath at 75° C. The system was kept under drying tube. Three (3) drops of DBTDL was added to initiate the polymerization. Polymerization was continued for 3 hours at 75° C. 0.5 g samples was withdrawn for % NCO titration to confirm the reaction. 4.134 grams of poly(ethylene oxide) methyl ether (Mn=2,000) in 10 grams of acetone was added to the reactor. The polymerization was continued 3 hours at 75° C. 0.5 gram of pre-polymer was withdrawn for final wt % NCO titration. The measured NCO value was 2.82 wt %. The theoretical wt % NCO should be 2.83 wt %. The polymerization temperature was reduced to 50° C. 7.480 grams of sodium 2-[(2-aminoethyl)amino]ethanesulphonate (Vestamin A-95, 50% in water) in 213.230 grams of DI water was added over 30 minutes. The solution became milky and white and the milky dispersion was continued to stir for overnight at room temperature. The PUD dispersion was filtered through 400 mesh stainless sieve. Acetone was removed with rotorvap at 50° C. (add 2 drops (20 mg) BYK-011 de-foaming agent). The final PUD dispersion was filtered through fiber glass filter paper. Particle size measured by Malvern Zetasizer is 182.7 nm; pH was 8.0; and solid content was 31.98 wt %.

### Example 3—Preparation of Polyurethane Particles PUB 3

63.177 g of g of polyester diol (Stepanpol® PC-1015-55), 26.062 g of 4,4′-methylene dicyclohexyl diisocyanate (H12MDI), 3.303 g of 1,4-butanediol and 64 g of acetone were mixed in a 500 ml of 4-neck round bottom flask. A mechanical stirrer with glass rod and Teflon blade was attached. A condenser was attached. The flask was immersed in a constant temperature bath at 75° C. The system was kept under drying tube. 3 drops of DBTDL was added to initiate the polymerization. Polymerization was continued for 3 hours at 75° C. 0.5 g samples was withdrawn for % NCO titration to confirm the reaction. 3.920 g of poly(ethylene glycol) methyl ether (Mn=2000) in 10 g of acetone was added to the reactor. The polymerization was continued 3 hours at 75° C. 0.5 g of pre-polymer was withdrawn for final % NCO titration. The measured NCO value was 2.65%. The theoretical % NCO should be 2.68%. The polymerization temperature was reduced to 50° C. 7.075 g of sodium 2-[(2-aminoethyl)amino]ethanesulphonate (Vestamin A-95, 50% in water) in 216.956 g of DI water was added over 30 min. The solution became milky and white color and the milky dispersion was continued to stir for overnight at room temperature. The PUB dispersion was filtered through 400 mesh stainless sieve. Acetone was removed with rotorvap at 50° C. (add 2 drops (20 mg) BYK-011 de-foaming agent). The final PUB dispersion was filtered through fiber glass filter paper. Particle size measured by Malvern Zetasizer is 291.1 nm. Its pH was 8.81. Solid content was 29.08%.

### Example 4—Preparation of Coating Composition and Printable Medium Samples

The raw materials and chemical components used in the illustrating samples are listed in Table 2.

TABLE 2

| Ingredients | Nature of the ingredients | Supplier |
|---|---|---|
| Araldite ® PZ 3901 | Cross-linked | Hundtsman Inc. |
| | polymeric network | |
| Aradur ® 3985 | Cross-linked | Hundtsman Inc. |
| | polymeric network | |
| Tegowet ® 510 | Surfactant | Evonik |
| | | Industries |
| Sancure ® 2016 | Polyurethane polymer | Lubrizol Inc. |
| Sancure ® 4010 | Self-Crosslinking aliphatic | Lubrizol Inc. |
| | polyurethane-acrylic network | |
| T0607 | Water soluble cationic | TCI America |
| Tetrakis | phosphonium salts | |
| (hydroxymethyl) | | |
| phosphonium | | |
| Chloride (ca. | | |
| 80% in Water), | | |
| T1089 | Water soluble cationic | TCI America |
| Tetrakis | phosphonium salts | |
| (hydroxymethyl) | | |
| phosphonium | | |
| Sulfate (ca. | | |
| 70-80% in Water) | | |

Different coating compositions were prepared and applied to a fabric media substrate at a weight bases of 120 gsm in order to form image-receiving coating layer. The formulation of the image-receiving coating layer IRL-1 to IRL-4 are illustrated in Tables 3 below. Each amount ingredient is expressed in parts by dry weight.

TABLE 3
Image-receiving coating layer (120)

| Ingredient | IRL-1 | IRL-2 | IRL-3 | IRL-4 |
|---|---|---|---|---|
| Tegowet ® 510 | 0.5 | 0.5 | 0.5 | 0.5 |
| Araldite ® PZ 3901 | 6.5 | 6.5 | 6.5 | 6.5 |
| Aradur ® 3985 | 6.5 | 6.5 | 6.5 | 6.5 |
| Sancure ® 2026 | — | — | 6 | 6 |
| Sancure ® 4010 | — | — | 5 | 5 |
| PUB 3 | 9 | 9 | — | — |
| T0607 | 3 | — | — | 3 |
| Tetrakis | | | | |
| (hydroxymethyl) | | | | |
| phosphonium | | | | |
| Chloride (ca. | | | | |
| 80% in Water), | | | | |
| THPC. | | | | |
| T1089 | — | 3 | — | — |
| Tetrakis | | | | |
| (hydroxymethyl) | | | | |
| phosphonium | | | | |
| Sulfate (ca. | | | | |
| 70-80% in Water) | | | | |
| Appearance of | No gelling | No gelling | No gelling | Gelled. |
| coating solution | | | | |
| after mixing | | | | |

Different media were made by applying the different image-receiving coating layer formulations IRL1, IRL-2 and IRL-3 onto a support base structure which is a 100% woven polyester fabric (with plain weave) having a weight of 120 gsm. The illustrating media samples 1 and 2 are fabric print medium in accordance with the principles described herein, i.e. coated with the image-receiving coating layer formulation IRL-1 and IRL-2. Samples 3 is comparative media samples, i.e. coated with the image-receiving coating layer formulation IRL-3. It was not possible to use the coating composition IRL-4 onto a fabric support base structure since the composition gelled after mixing.

### Example 5—Samples Performances

The same images are printed on the experimental media samples 1 and 2 and Comparison Samples 3 using a HP® DesignJet L360 Printer equipped with HP 789 ink cartridge (HP Inc.). The printer was set with a heating zone temperature at about 50° C., a cure zone temperature at about 110° C., and an air flow at about 15%. The resulting printed fabric mediums are evaluated for different performances: image quality, image durability and flame resistance. The results of these tests are expressed in the Table 4 below.

TABLE 4

| | | | Weight | Flame | | Wrinkle | |
|---|---|---|---|---|---|---|---|
| | Coating | | loss % | stop | Dry | (white | |
| Sample | solution | Color | after | time | rub | line) | Scratch |
| ID | ID | gamut | ignition | (sec) | test | test | test |
| EXP 1 | IRL-1 | 305,000 | 5.0% | 1.3 | 4 | 5 | 4 |
| EXP 2 | IRL-2 | 302,000 | 9.3% | 1.7 | 4 | 5 | 4− |
| EXP 3 | IRL-3 | 303,000 | 7.3% | 9.7 | 4 | 5 | 4 |
| (compar- | | | | | | | |
| ative) | | | | | | | |

| | | |
|---|---|---|
| EXP 4 | IRL-4 | Couldn't process for coating due to gelling |
| (compar- | | of the solution |
| ative) | | |

Image quality is evaluated using numeric measurement method. The image quality of the prints is measured with Gamut. Gamut Measurement represents the amount of color space covered by the ink on the media sample (a measure of color richness). The gamut is measured on Macbeth®TD904 (Micro Precision Test Equipment, California) (A higher value indicates better color richness).

Image Durability is evaluated with rub resistance, wrinkle resistance, and scratch resistance tests. Rub resistance testing is carried out using an abrasion scrub tester (per ASTM D4828 method): fabrics are printed with small patches of all available colors (cyan, magenta, yellow, black, green, red, and blue). A weight of 250 g is loaded on the test header. The test tip is made of acrylic resin with crock cloth. The test cycle speed is 25 cm/min and 5 cycles are carried out for each sample at an 8-inch length for each cycle. The test probe is in dry (dry rub) mode.

Scratch test is performed by exposing the various samples to be tested to a 45-degree coin scratching under a normal force of 800 g. The test is done in a BYK Abrasion Tester (from BYK-Gardner USA, Columbus, Md.) with a linear, back-and-forth action, attempting to scratch off the image-side of the samples (5 cycles). The image durability was evaluated visually from the printed samples using a scale of 1-5 (with 1 being the worst and 5 being the best with 3 as a passing point).

Wrinkle test (white line test) is done by per HP standard HP-91004581 by printing the coated sample with 11×13″ black image using a HP® DesignJet L360 Printer equipped with HP 789 ink cartridge (HP Inc.) in a condition of 20 passes and 260% black ink. The dried and cured black image is crumped in the hands and hold for 1 minute before flat it out on the table for 15 min. The results are visually evaluated in grade from 1-5 with 5 as the best.

The printed image sample are also evaluated for their flame-resistance properties. Such analyze is done per NFPA 701 Standard which measures the ignition resistance of a fabric printing media after it is exposed to a flame for 12 seconds. The Weight loss % after ignition and flame stop time (in second) are recorded. (NFPA 701 pass standard: weight %<40%, Flame stop time<2 sec).

1) A coating composition comprising water, water-soluble cationic phosphonium salts and polyurethane particles including sulfonated- or carboxylated-diamine groups, isocyanate-generated amine groups, and polyalkylene oxide side-chains.

2) The coating composition of claim 1 wherein the water-soluble cationic phosphonium salts has a molecular weight less that is less than 1,000.

3) The coating composition of claim 1 wherein the water-soluble cationic phosphonium salts contains single or multiple hydroxyl groups connecting directly with phosphorus element.

4) The coating composition of claim 1 wherein the water-soluble cationic phosphonium salts contains has the general structure (I) 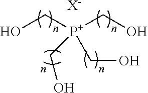
wherein, X− can be any counterion and n is an integers ranging from 1 to 10.

5) The coating composition of claim 1 wherein the water-soluble cationic phosphonium salt is a tetrakis(hydroxymethyl) phosphonium chloride or a bis[tetrakis(hydroxymethyl) phosphonium]sulfate.

6) The coating composition of claim 1, wherein the polyurethane particles have a D50 particle size from 20 nm to 300 nm.

7) The coating composition of claim 1, wherein the polyurethane particles have an acid number ranging from 0 mg KOH/g to 30 mg KOH/g.

8) The coating composition of claim 1, wherein, in the polyurethane particles, the polyalkylene oxide side-chains include polyethylene oxide side-chains, polypropylene oxide side-chains, or a combination thereof, and wherein the polyalkylene oxide side-chains have a number average molecular weight from 500 Mn to 15,000 Mn.

9) The coating composition of claim 1, wherein the polyurethane particles further comprises polymerized nonionic aliphatic diols.

10) The coating composition of claim 1, further comprising a fixing agent including metal inorganic salt, metal organic salt, cationic polymer, or a combination thereof.

11) The coating composition of claim 10, wherein the fixing agent is cationic polymer, and wherein polyurethane particles and the cationic polymer are present at a weight ratio from 2:1 to 20:1.

12) A coated printable medium, with an image-side and a back-side, comprising:
a. a base substrate;
b. and a coating composition applied over, at least, one side of the base substrate, forming an image-receiving layer, and comprising water, water-soluble cationic phosphonium salts and polyurethane particles including sulfonated- or carboxylated-diamine groups, isocyanate-generated amine groups, and
polyalkylene oxide side-chains.

13) The coated printable medium of claim 12 wherein the base substrate is a fabric base substrate.

14) The coated print medium of claim 12, wherein the coating composition further comprises fixing agents including metal inorganic salt, metal organic salt, cationic polymer, or a combination thereof.

15) A method of making a coated printable medium comprising:
a. applying a coating composition as a layer to a media substrate, the coating composition including water, water-soluble cationic phosphonium salts and polyurethane particles including sulfonated- or carboxylated-diamine groups, isocyanate-generated amine groups, and polyalkylene oxide side-chains;
b. drying the coating composition to remove water from the media substrate to leave an ink-receiving layer thereon.
